(19) United States
(12) Patent Application Publication
(10) Pub. No.: US 2006/0169423 A1
(43) Pub. Date: Aug. 3, 2006

(54) Collapsible stand for bicycle

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/050,386

(22) Filed: Feb. 3, 2005

(51) Int. Cl. E06B 7/28

(52) U.S. Cl. 160/180

(57) ABSTRACT

A collapsible stand is provided for a bicycle. The bicycle includes a front wheel, a rear wheel, a crank and a pedal. The collapsible stand includes a body and at least one leg pivotally connected with the body for cooperating with the front wheel and the rear wheel in order to form a stable three-point supporting situation.

### BACKGROUND OF INVENTION

1. Field of Invention

The present invention relates to a bicycle and, more particularly, to a collapsible stand for a bicycle.

2. Related Prior Art

Referring to FIG. 11, a conventional stand 1 includes a body 2 and four legs 3 firmly mounted on the body 2. The legs 3 are supported on the ground. The body 2 includes a space (not shown) for receiving a crank 4 of a bicycle (not numbered) so that the stand 1 can support the bicycle. It is difficult for a rider to carry such a stand because it is heavy and bulky.

The present invention is therefore intended to obviate or at least alleviate the problems encountered in prior art.

### SUMMARY OF INVENTION

A collapsible stand is provided for a bicycle. The bicycle includes a front wheel, a rear wheel, a crank and a pedal. The collapsible stand includes a body and at least one leg pivotally connected with the body for cooperating with the front wheel and the rear wheel in order to form a stable three-point supporting situation.

The primary advantage of the stand according to the present invention is that it can be collapsed and easily carried because it occupies a small space in the collapsed mode.

The primary advantage of the present invention is to provide a collapsible stand that is small in size and light in weight.

Other objects, advantages, and novel features of the invention will become more apparent from the following detailed description when taken in conjunction with the drawings.

### BRIEF DESCRIPTION OF DRAWINGS

The present invention will be described through detailed illustration of the preferred embodiment referring to the drawings.

FIG. 1 is a perspective view of a collapsible stand for a bicycle according to the preferred embodiment of the present invention.

FIG. 2 is an exploded view of the collapsible stand shown in FIG. 1.

FIG. 3 is a perspective view of the bicycle supported by means of the collapsible stand.

FIG. 4 is a front view of the bicycle supported by means of the collapsible stand.

FIG. 5 is a side view of the bicycle supported by means of the collapsible stand shown in FIG. 4.

FIG. 6 is similar to FIG. 1 but shows the collapsible stand in a collapsed mode.

FIG. 7 is a perspective view of a collapsible stand according to a second embodiment of the present invention.

FIG. 8 is a cross-sectional view of the collapsible stand shown in FIG. 7.

FIG. 9 is a similar to FIG. 8 but shows the collapsible stand in a different position.

FIG. 10 is a similar to FIG. 9 but shows the collapsible stand in a different position.

FIG. 11 is a perspective view of a bicycle supported by means of a conventional stand.

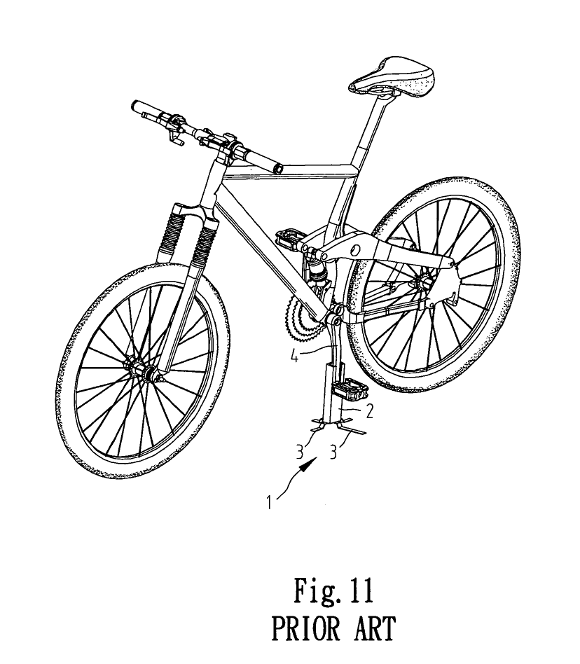

### DETAILED DESCRIPTION OF PREFERRED EMBODIMENT

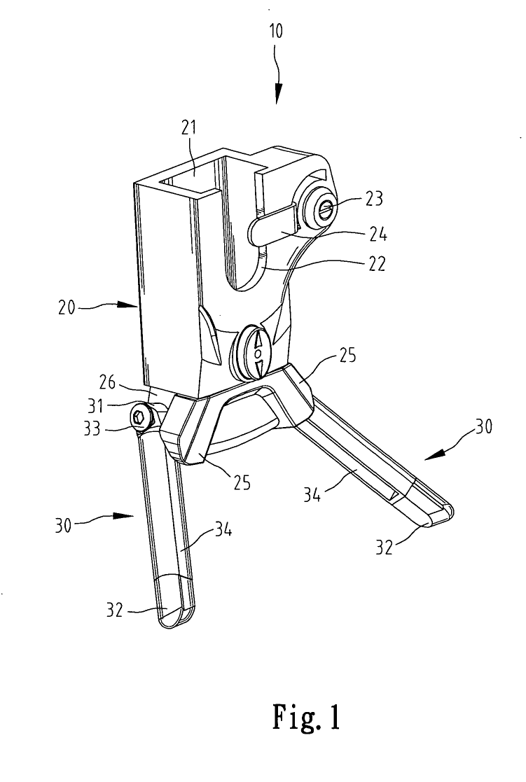

FIG. 1 shows a collapsible stand 10 according to the preferred embodiment of the present invention in a fully extended position.

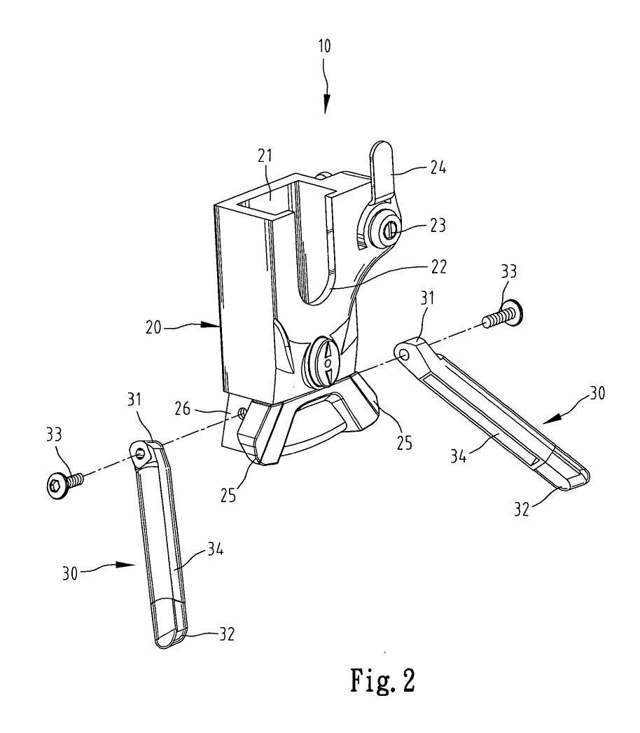

Referring to FIG. 2, the collapsible stand 10 includes a body 20 and two legs 30. The body 20 includes first and second ends. The first end of the body 20 includes a space 21, a cutout 22 communicated with the space 21, a lock 23 installed thereon and a latch 24 extending from the lock 23. The body 20 includes two inclined faces 26 near the second end and two restraints 25 each formed on a related inclined face 26.

Each leg 30 includes a first end 31 and a second end 32. Each leg 30 includes an inclined face formed at the first end 31 thereof and a groove 34 defined in a center thereof. The second end 32 of each leg 30 can be supported on the ground.

The inclined face of each leg 30 matches one of the inclined faces 26 of the body 20. A bolt 33 is driven into a screw hole in each inclined face 26 through an aperture in the first end 31 of each leg 30. Thus, the legs 30 are pivotally connected with the body 20.

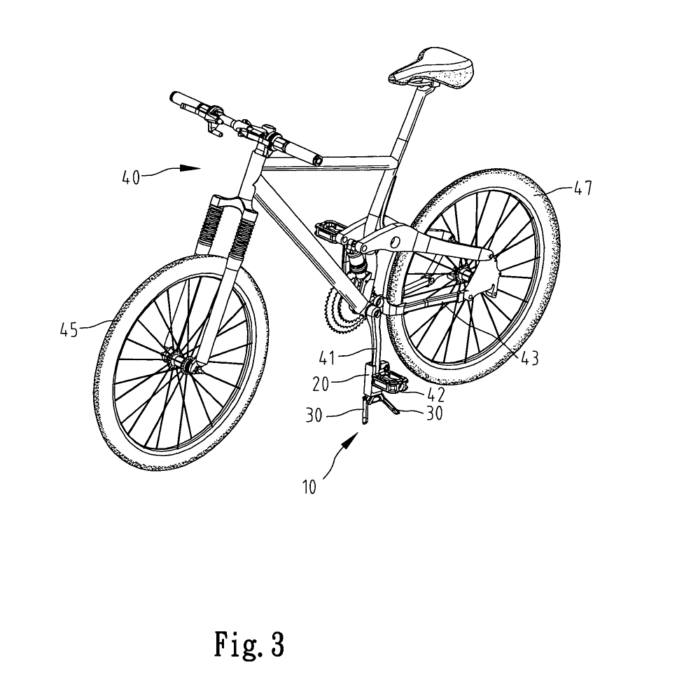

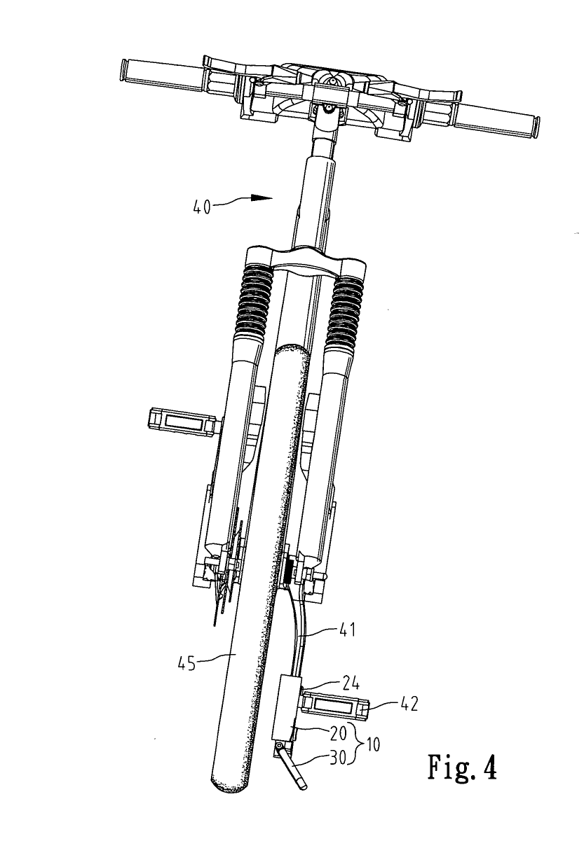

FIGS. 3 and 4 show a fully extended collapsible stand 10 for supporting a bicycle 40. A crank 41 of the bicycle 40 is put in the space 21 (see FIG. 1) of the body 20 and a pedal 42 extends from the body 20 through the cutout 22 (see FIG. 1). The lock 23 is driven with a key (not shown) so that the latch 24 is moved. The latch 24 can be abutted against the crank 41 so as to lock the crank 41 to the body 20. A front wheel 45 and a rear wheel 47 of the bicycle 40 and two legs 30 form a stable four-point supporting condition. Thus, the bicycle is kept in a stable situation.

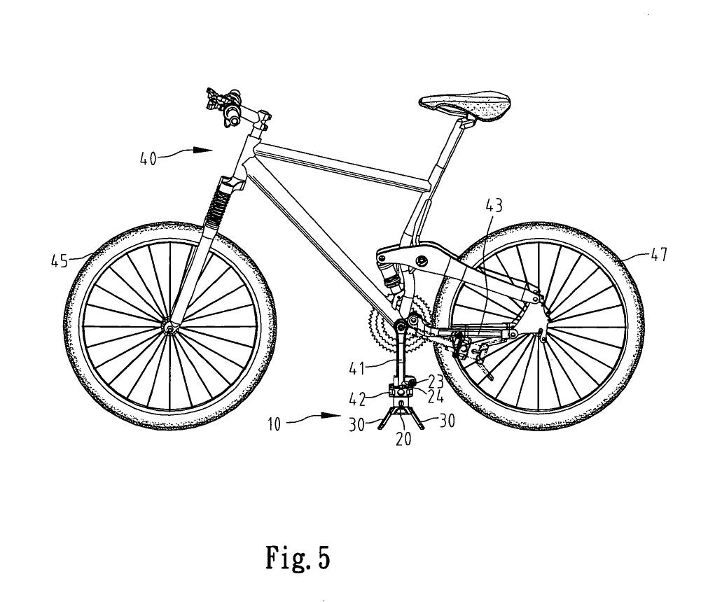

FIG. 5 shows the fully extended collapsible stand 10 jammed with a chain stay 43. The crank 41 of the bicycle 40 is moved toward the chain stay 43. The collapsible stand 10 is also moved because it is locked to the crank 41. The collapsible stand 10 is jammed with the chain stay 43 when the crank 41 is moved to the chain stay 43. Thus, the stand 10 hinders the operation of the crank 41. In this aspect, the stand 10 functions as a security device.

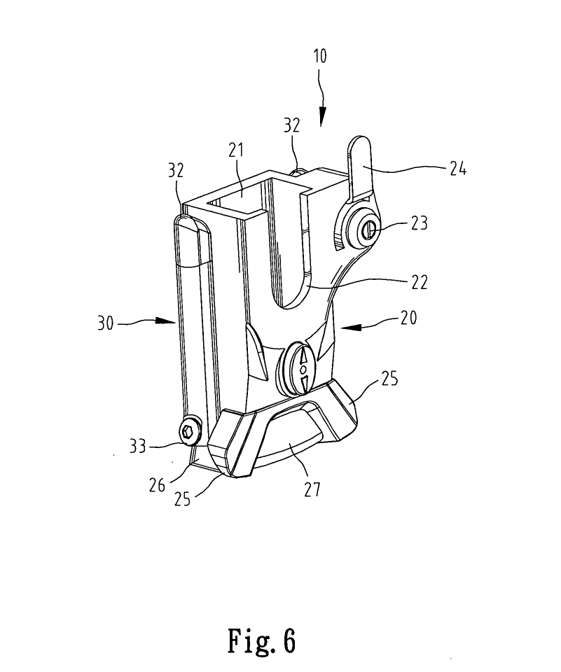

FIG. 6 shows the collapsible stand 10 in a collapsed mode. The legs 30 can be pivoted relative to the body 20 so that each of the legs 30 abuts against corresponding one of the restraints 25. Thus, the collapsible stand 10 is kept in the collapsed mode.

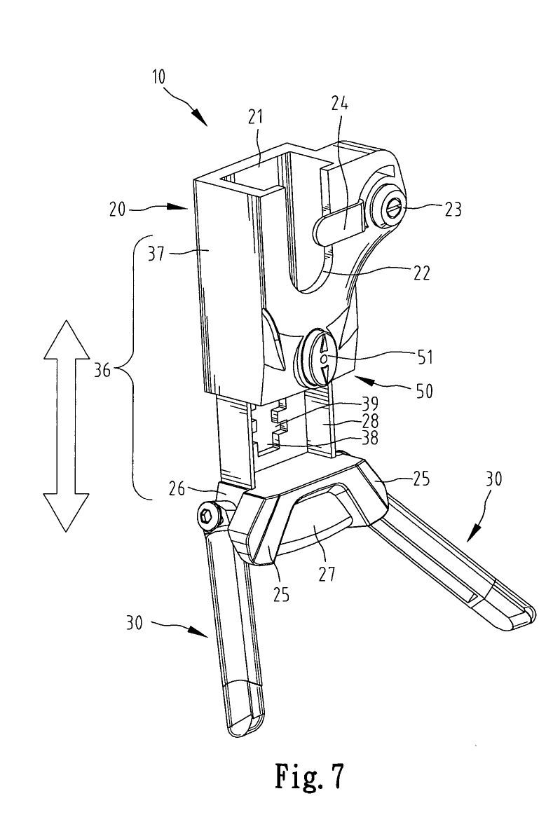

Referring to FIGS. 7 to 10, a collapsible stand according to a second embodiment of the present invention is shown. The second embodiment is identical to the first embodiment except for including an extensible body 36 instead of the body 20 and for including a positioning device 50 for keeping the extensible body 36 in one of several positions.

The extensible body 36 includes a sleeve 37, a block 27 and a slide 28 that is extended from the block 27 and connected with the sleeve 37 in a movable manner. The sleeve 37 is similar to an upper portion of the body 20. The block 27 is similar to a lower portion of the body 20. In other words, the sleeve 37 and the block 27 are formed through cutting the body 20 into two pieces. Hence, the sleeve 37 and the block 27 will be described in detail.

The slide 28 defines a longitudinal slot 38 and a plurality of transverse slots 39 communicated with the longitudinal slot 38. The slide 28 is connected with the sleeve 37 in a movable manner.

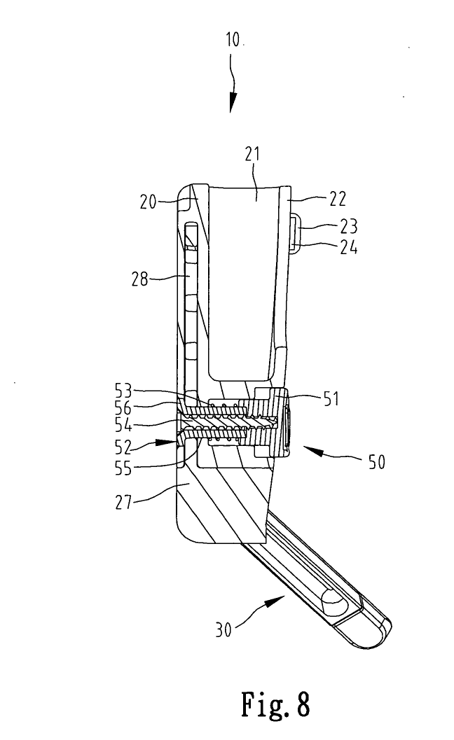

Referring to FIG. 8, the positioning device 50 includes a button 51, a positioning element 52 and a spring 53. The positioning element 52 includes a cylinder 55 and a plank 56 transversely formed at an end of the cylinder 55. The cylinder 55 is inserted through the longitudinal slot 38. The plank 56 is put in one of the transverse slots 39. Thus, the slide 28 is kept in one of several positions relative to the locking device 50. That is, the block 27 is kept in one of several positions relative to the sleeve 37. The cylinder 55 is connected with the button 51 by means of a screw 54. The spring 53 is installed on the cylinder 55 and compressed between the button 51 and the sleeve 37.

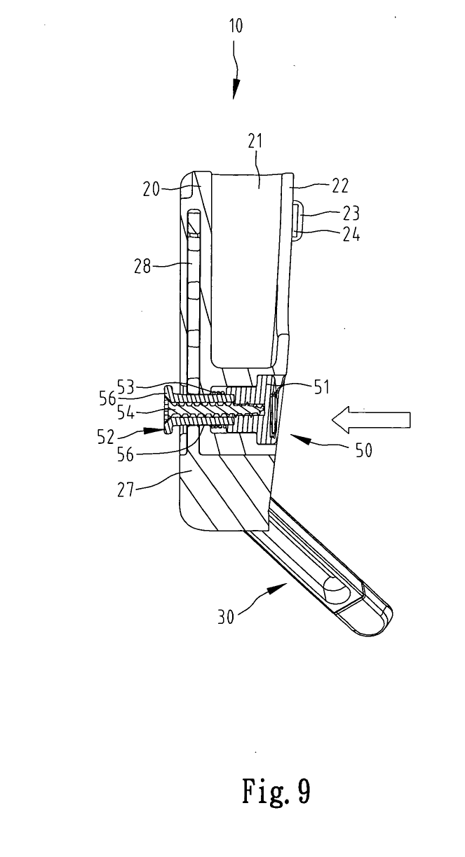

Referring to FIG. 9, the button 51 is pushed. The plank 56 is moved from the transverse slots 39. Thus, the slide 28 can be moved relative to the cylinder 55. That is, the block 27 can be moved relative to the sleeve 37. That is, the extensible body 36 can be extended or withdrawn. The spring 53 is compressed.

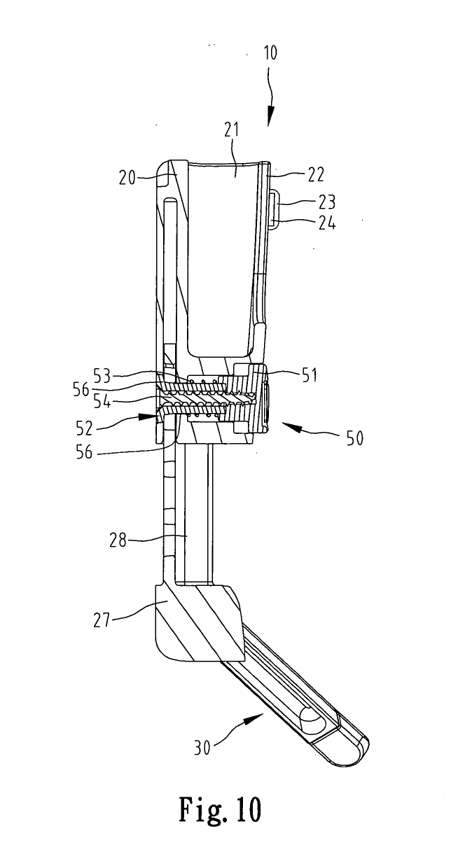

Referring to FIG. 10, after the plank 56 is aligned with another transverse slot 39 than that is shown in FIG. 8, the button 51 is released. Biased by the spring 53, the plank 56 is put in this transverse slot 39. Thus, the slide 28 is kept in a new position relative to the locking device 50. That is, the block 27 is kept in a new position relative to the sleeve 37.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

What is claimed is:

1. A collapsible stand for a bicycle, the bicycle including a front wheel, a rear wheel, a crank and a pedal, the collapsible stand comprising a body and at least one leg pivotally connected with the body for cooperating with the front wheel and the rear wheel in order to form a stable three-point supporting situation.

2. The collapsible stand according to claim 1 wherein the body defines a space for receiving the crank.

3. The collapsible stand according to claim 1 wherein the body defines a cutout for receiving the pedal.

4. The collapsible stand according to claim 1 comprising a lock installed on the body for locking the crank to the body.

5. The collapsible stand according to claim 4 wherein the lock comprises a latch for pivotal between a locking position and a releasing position.

6. The collapsible stand according to claim 1 wherein the body comprises at least one restraint formed thereon for abutment against the leg in a fully extended position.

7. The collapsible stand according to claim 1 wherein the body comprises at least one restraint formed thereon, wherein the leg abuts against the restraint in a collapsed mode.

8. The collapsible stand according to claim 1 wherein the leg defines a groove in order to reduce the weight in each leg.

9. The collapsible stand according to claim 1 comprising at least one bolt for connecting the leg with the body.

10. The collapsible stand according to claim 1 comprising two legs both pivotally connected with the body.

11. The collapsible stand according to claim 1 wherein the body comprises a fixed configuration.

12. The collapsible stand according to claim 1 wherein the body comprises an extensible configuration.

13. The collapsible stand according to claim 12 comprising a positioning device installed on the sleeve for keeping the extensible body in one of several positions.

14. The collapsible stand according to claim 12 wherein the extensible body comprises a sleeve for receiving the crank, a block pivotally connected with the leg and a slide extended from the block and movably connected with the sleeve.

15. The collapsible stand according to claim 14 comprising a positioning device installed on the sleeve for keeping the slide in one of several positions relative to the sleeve.

16. The collapsible stand according to claim 15 wherein the slide defines a plurality of transverse slots, wherein the positioning device comprises a plank for fitting in one of the transverse slots.

17. The collapsible stand according to claim 16 wherein the slide defines a longitudinal slot communicated with the transverse slots, wherein the positioning device comprises a cylinder extended from the plank and inserted through the longitudinal slot.

18. The collapsible stand according to claim 17 wherein the positioning device comprises a button attached to the cylinder.
